(19) United States
(12) Patent Application Publication
(10) Pub. No.: US 2010/0008476 A1
(43) Pub. Date: Jan. 14, 2010

(54) TESTING SYSTEM AND METHOD FOR TESTING A MODEM INTERFACE FUNCTION OF A COMPUTER

(75) Inventor: GUANG-YU ZHU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/206,667

(22) Filed: Sep. 8, 2008

(30) Foreign Application Priority Data
Jul. 8, 2008 (CN) 200810302629.6

(51) Int. Cl. H04M 3/08

(52) U.S. Cl. 379/1.03

(57) ABSTRACT

A testing system includes a computer with a modem interface to be tested, a telephone, and a telephone simulator having two input ports electrically respectively coupled to a modem in the computer and the telephone. The computer has a main test procedure capable of sending commands to the telephone via the telephone simulator, receiving feedback signals from the telephone, and determining if the modem interface is functioning properly according to the feedback signals. A testing method utilizing the above-described testing system is also disclosed.

### BACKGROUND

1. Technical Field

The present invention relates to a testing system and method for testing a modem interface function of a computer.

2. Description of Related Art

Products are typically tested at several stages during assembly to identify potential issues with components at a subassembly level and ensure the final product meets all of a manufacturer's requirements. Motherboards are a critical component of personal computers and should be tested prior to being installed in personal computers. One such test examines a modem interface function of personal computers. A typical system for testing the modem interface function of a personal computer motherboard includes a telephone simulator, a testing computer with a modem interface coupled to one port of the telephone simulator, and a computer with a modem interface to be tested coupled to another port of the telephone simulator. During testing, programs are executed on the computers, and the testing computer transmits signals to the computer to be tested. If the testing computer can receive signals from the computer to be tested, and vice versa, the modem interface on the computer to be tested is functioning properly. The typical testing system requires an additional testing computer with a modem interface in order to function properly, thereby increasing the overall testing costs.

Therefore, a new testing system and method for testing the modem interface function of a computer is desired to overcome the above-described deficiencies.

### BRIEF DESCRIPTION OF THE DRAWINGS

FIG. 1 is a block diagram of an embodiment of a testing system for testing a modem interface function of a computer; and

FIG. 2 is a flow chart illustrating a method for testing a modem interface function of a computer.

### DETAILED DESCRIPTION OF THE EMBODIMENTS

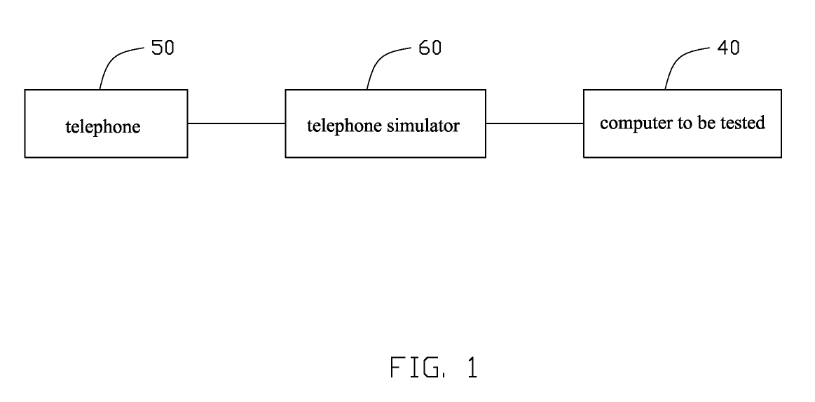

FIG. 1 is a block diagram of an embodiment of a testing system (not labeled) for testing a modem interface function of an electronic product, such as a computer. In the illustrated embodiment, the testing system includes a computer 40 with a modem interface (not labeled) to be tested, a telephone 50, and a telephone simulator 60 with two input ports. A modem (not labeled) in the computer 40 is electrically coupled to one input port of the telephone simulator 60 via an RJ11 telephone wire (not labeled). The telephone 50 is electrically coupled to the other input port of the telephone simulator 60 via an RJ11 telephone wire (not labeled). During this process, the telephone 50 is off the hook.

The computer 40 is configured with a main test procedure which sends AT commands to the telephone 50 via a telephone simulator 60. The main test procedure in the computer 40 is configured to determine if the modem interface (not labeled) of the computer 40 is functioning properly if it receives feedback signals from the telephone 50.

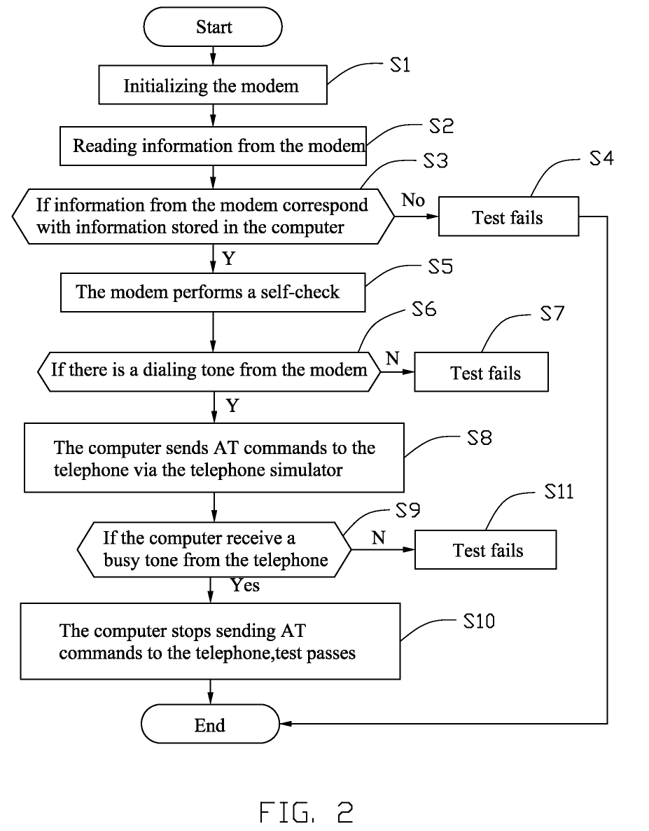

FIG. 2 is a flow chart illustrating a method for testing the modem interface function of the computer. Depending on the embodiment, certain steps described below may be removed, while others may be added, and the sequence of the steps may be altered. In one embodiment, the method for testing the modem interface function of a computer utilizing the above-described testing system includes the following steps:

S1: initializing the modem in the computer 40 to be tested;

S2: reading information from the modem;

S3: comparing information from the modem with information stored in the computer 40;

S4: determining the test fails if the information from the modem does not correspond with the information stored in the computer 40;

S5: performing a self-check if the information from the modem corresponds with the information stored in the computer 40;

S6: performing a self-check by detecting if there is a dialing tone from the modem;

S7: determining the test fails if there is no dialing tone from the modem;

S8: invoking the main test procedure in the computer 40 and sending AT commands to the telephone 50 via the telephone simulator 60 if there is a dialing tone from the modem;

S9: detecting if there is a busy tone from the telephone 50;

S10: determining the test passes and stopping the computer 40 from sending AT commands to the telephone 50 if there is a busy tone from the telephone 50; and

S11: determining the test fails, if there is no busy tone from the telephone 50.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A testing system comprising:
a telephone simulator having a plurality of input ports;
a computer having a modem interface to be tested, the computer comprising a modem electrically coupled to a first of the plurality of input ports; and
a telephone electrically coupled to a second of the plurality of input ports;
wherein the computer is configured to send commands to the telephone via the telephone simulator, receive feedback signals from the telephone, and determine if the modem interface functions properly according to the feedback signals.

2. The testing system of claim 1, wherein the modem interface functions properly when the computer receives a busy tone feedback signal from the telephone.

3. The testing system of claim 2, wherein the modem interface is not functioning properly when the computer does not receive the busy tone feedback signal from the telephone.

4. The testing system of claim 3, wherein the computer sends a series of AT commands to the telephone.

5. A testing method for testing a modem interface function of an electronic product, the method comprising:
initializing a modem in the electronic product to be tested;
detecting if there is a dial tone from the modem; if there is no dial tone from the modem, the test fails; if there is the dial tone from the modem, the electronic product sends commands to a telephone via a telephone simulator; and
determining if the modem of the electronic product functions properly according to feedback signals from the telephone.

6. The testing method of claim 5, further comprising comparing information from the modem with information stored in the electronic product after initializing the modem.

7. The testing method of claim 6, further comprising performing a self-check process of the modem by detecting if there is a dialing tone from the modem.

8. The testing method of claim 7, further comprising determining the modem functions properly if the electronic product receives a busy tone feedback signal from the telephone.

9. The testing method of claim 8, further comprising determining the modem is not functioning properly if the electronic product does not receive the busy tone feedback signal from the telephone.

10. A testing system for testing a modem interface function of an electronic product comprising a modem, the testing system comprising:
a telephone simulator having two input ports, a first of the two input ports is electrically coupled to the modem; and
a telephone electrically coupled to a second of the two input ports;
wherein the electronic product is configured to send commands to the telephone via the telephone simulator, receive feedback signals from the telephone, and determine if the modem interface functions properly according to the feedback signals.

11. The testing system of claim 10, wherein the electronic product further comprises a main test procedure to send commands to the telephone.

12. The testing system of claim 11, wherein the electronic product sends a series of AT commands to the telephone.
